(19) United States
(12) Patent Application Publication
(10) Pub. No.: US 2015/0242444 A1
(43) Pub. Date: Aug. 27, 2015

(54) CODED IMAGE SHARING SYSTEM (CISS)

(71) Applicants: Don E.K. CAMPBELL, (US); Heather CAMPBELL, (US)

(72) Inventors: Don E. Campbell, Longwood, FL (US); Heather L. Campbell, Longwood, FL (US)

(21) Appl. No.: 14/424,173

(22) PCT Filed: Aug. 27, 2013
(86) PCT No.: PCT/US13/56849

§ 371 Date: Feb. 26, 2015

Related U.S. Application Data
(60) Provisional application No. 61/694,099, filed on Aug. 28, 2012.

(51) Int. Cl. G06F 17/30; H04N 1/32; H04N 1/44; H04N 1/00

(52) U.S. Cl. CPC G06F 17/30268; H04N 1/00244; H04N 1/00334; H04N 1/32128; H04N 1/444; G06F 17/3028; H04N 2201/0084

(57) ABSTRACT

A system for collecting, creating, and distributing images and videos includes a smart application, executable on a smart device, the smart application providing for the control of the imaging and video capture device of the smart device. The system further includes a server, the server in communication with the smart application via the smart device, the smart application receiving a code, the code being associated with images generated by the smart device resulting in coded images through the control of the smart device by the smart application, the smart application uploading the coded images to the server, the server providing access to the coded images according to access preferences.

### CROSS-REFERENCED TO RELATED APPLICATIONS

This application is a National Stage Application of PCT/US 13/56849 filed on Aug. 27, 2013, which claims the benefit of U.S. Provisional Application No. 61/694,099 filed on Aug. 28, 2012, both of which are incorporated by reference in their entirety.

### SUMMARY

This disclosure relates to systems and methods of coordinating events, and the associated filing, sharing, and disseminating of information gathered at those events, between the members of the event and any storage media (pictures, audio, files, videos, scans, digital notes, digital impressions, etc.) and/or the social networks to which they ultimately belong, and more particularly to systems and methods of managing pictures and videos wherein those taken by an individual or a group of people can easily be shared within the group members or openly with other like-minded groups or individuals based on factors including, but not limited to, an actual event, locations, GPS positioning, social criteria, dates (birthdays, anniversary, etc.) and holidays, clubs, memberships, invitations, landmarks, or proximity to other users of the System.

Regarding the capturing of pictures (hardware) and videos and other media, the primary function of such devices is to record a moment in time to be shared with other people at some point in the future. Recording instruments and their availability are pervasive everywhere. The inclusion of cameras (video and photography) now available in most cellular telephones, laptops, tablets, desktops, computers, surveillance, and other personal portable equipment, has made for a public consumed with capturing every event.

An important function of capturing files is the moving of the files to a computer or server or other media for eventual sorting, dissemination, and preservation.

Due to the need for dissemination, the files at some point have to be identified or tagged, the medium for sending those files has to be chosen, a location to store the files has to be determined, and the receiver has to have the opportunity to review them.

It is desirable that everyone in attendance (or invited) could easily have access to everyone else's pictures.

Thus, picture takers would appreciate a method that automatically facilitates the ability of many people to upload, view, and share their files, and with improved efficiency.

According to one aspect of the disclosure, a method of identifying images uses the event on the event code, such as a QR code or other bar code or symbolic technology.

According to another aspect of the disclosure, a method for presorting a file or files by using an event code (such as a QR Code) is delivered to the user hardware through an application or software, and through which the user will be given the option to share the event code (through downloading, webpage point and click, texting, email, or scanning, “bumping,” or near field communications, etc.) making available the access to and dissemination of those files with other like-minded people at the event, before the event, or after the event at a later time.

According to another aspect of the disclosure, a method of labeling images attaches the QR code to the files singularly or as a collection in order to facilitate the tagging, pre-approval, collection, and proper sorting of files for later viewing or dissemination.

According to another aspect of the disclosure, a method of creating uses event codes (QR codes) determined via filters such as event name, start/end time, place, GPS position, landmark identifiers (mobile visual search (MVS) picture recognition technology), world events (i.e., Super Bowl, Olympics, television shows), clubs, memberships, or proximity to other users of the system.

According to another aspect of the disclosure, a method of retrieving images searches and retrieves event codes (QR codes) via filters such as event name, world events, start/end time, place, GPS position, landmark identifiers (mobile visual search (MVS) picture recognition technology), or proximity to other users of the system.

According to another aspect of the disclosure, a method of tagging images uses an event code (such as a QR Code) which is delivered to the user hardware through an application or software, and through which the user has the option to share the event code with other users or entities (computerized or human) before, during, or after the event.

According to another aspect of the disclosure, a method of tagging images uses an event code (such as a QR Code) which is delivered to the user hardware through an application or software, and through which the user has the option to share the event code with other users or entities (computerized or human) before, during, or after the event and interfacing the event code with the servers (software and hardware) where the files are transmitted, and whereby the limitations or preferences defined by the administrator of the event code allow the user to join the event, store, and disseminate their files.

According to another aspect of the disclosure, a method of tagging images uses an event code (such as a QR Code) which is delivered to the user hardware through an application or software, and through which the user has the option to share the event code with other users or entities (computerized or human) before, during, or after the event and interfacing the event code with the servers (software and hardware) where the files are transmitted, and whereby the limitations or preferences defined by the administrator of the event code allow the user to join the event, store, and disseminate their files according to the wishes of the user and their own preferences.

According to another aspect of the disclosure, a method of sharing images uploads the files from the user hardware to be shared with other users, according to the profile preferences created by the user before the event either stored in the application software or on the server.

Another aspect of the disclosure includes a method for uploading the files from the user hardware to be shared with other users, according to the demands of the user, as the files are created.

According to another aspect of the disclosure, a method for sharing images uploads the files from the user hardware to be shared with other users, according to a timeline created by the user.

According to another aspect of the disclosure, a method for sharing images uploads the files from the user hardware to be shared with other users, according to a timeline created by the user or administrator.

According to another aspect of the disclosure, a method for sharing images uploads the files from the user hardware to be shared with other users, according to a proximity to Wi-Fi or other network access. The Wi-Fi access may also form a commonality whereby users of the system will be able to identify that other users are actively engaged (whether previously or concurrently) in the use of the system nearby.

According to another aspect of the disclosure, a method of sorting images automatically presorts a file or files by using an event code (such as a QR Code) which is delivered to the user through an application or software, and through which the user attains a file or files by searching for events which have been tagged according to their name, location, landmark, date, time, social function, or network of friends, relatives, or colleagues, or like-minded groups of people that are intending to attend, are at the event, or have been at the event.

According to another aspect of the disclosure, a method of sorting images attaches an event code to any number of files previously stored on the hardware for sharing and dissemination. This is useful for pictures taken prior to receiving an event code.

According to another aspect of the disclosure, a method identifies users of the system by their phone number, IEN, or IP Address alone (etc.), and provides them access to their files based on their event code. Eventually, these users can create their own login identification and personal profile into the system by receiving a password sent to their hardware and entering it on the system website/server. The CISS system is configured to track users by phone number or IP address when they first login and setup profile that tracks the images upload merely on the basis of the phone number or in some alternatively even IP address. In this way no official account setup is need to utilize the CISS system.

For example, it is commonly known among wedding-goers that cameras are left on the invitees' table so that the bride/groom/wedding party can collect the cameras and see pictures taken by anyone in attendance. This allows the members in the wedding party to see the wedding through another's perspective, especially when they are too busy to take pictures themselves.

In one embodiment, the CISS system works in a similar way but with much greater efficiency. The current system shares files taken by one or many with a common interest, to be shared with many. In this embodiment, the event code is first created by the Bride/Groom (Administrator) by logging directly into the Pixtmatic.com website/server (whatever is decided). (Alternatively, the event code may be created at will, directly on the hardware—camera, smart phone, etc. —of any user that has the application or software to integrate with the server side).

The event code may be “Private” whereby the Administrator does not allow sharing of the event code (traditionally private would be the “wedding invitation”) or by open access, allowing anyone that attains an event code to share it with anyone else (as long as the timelines/restrictions imposed by the Administrator are valid). If “Private” event codes were generated, only those people receiving the actual event code can use the system. If “Open” event codes were generated, then the invitees could freely distribute and invite other wedding guests, passersby, etc., to contribute their files (and view/access everyone else's files).

Once the event code is detected by the hardware (camera, smart phone, etc.) through the application software loaded, the pictures taken then are uploaded to the server (either on demand through Wi-Fi, direct data exchange network, VPN, Internet, wireless, cable, FM, satellite, cellular service, etc.) or at some future point in time as so defined by the user or administrator. As all users (invitees) are sharing the same event code, all their files will eventually be uploaded to a server and will be sorted according to the event and the permissions imposed by the Administrator and/or user profile. Anyone that has accepted the event code and “digitally affixed” it to their pictures can gain access to the pictures that everyone else took at the wedding. The current state of the art requires inviting people to your website to view the pictures, or to gather up all the pictures and send them out; but there is no easy way for everyone that wants to be included in the same event to share their files with everyone else.

An event code “tag” will be attached to every picture taken while the application is engaged. This will allow people, at any time, including years in the future, to view the properties of the picture, click on the event code, and automatically return to all the pictures taken by all the users at the same event to which that event code applied. The event code will be a perpetual yearbook, connecting people to their past videos and pictures (files) and at any time allowing them to see other pictures taken at the same event even if the event occurred over many days, weeks, or years.

According to another aspect of the disclosure, a method of creating groups seeks other applications currently being used or which are open for inclusion, or have been used in or near a given location, or for a given group of people, or event, or landmark, even without receiving a direct invite from another event code holder (Open invite) or Administrator.

In one embodiment, a system for collecting, creating, and distributing images and videos includes a smart application, executable on a smart device, the smart application providing for the control of the imaging and video capture device of the smart device. The system further includes a server, the server in communication with the smart application via the smart device, the smart application receiving a code, the code being associated with images generated by the smart device resulting in coded images through the control of the smart device by the smart application, the smart application uploading the coded images to the server, the server providing access to the coded images according to access preferences. Optionally, the code is a QR code. Alternatively, scanning the QR code with the smart device causes the smart application to associate subsequently captured images with the QR code. In one alternative, the subsequently captured images are associated with the QR code only for a set period of time, the set period of time related to the length of an event the QR code is associated. In another alternative, the subsequently captured images are associated with the QR code only while a location of the smart device is in a certain geographical area. In one configuration, the certain geographical area is associated with an event and the location of the smart device is determined according to GPS. In another configuration, the certain geographical area is associated with an event and the location of the smart device is determined according to wireless signals. Optionally, the access preferences define that those users who have scanned the QR code may access the coded images. Alternatively, the smart application is executable on a second smart device, and when the second smart device captures second images after receiving the code, the second smart device associates the code with the second images and uploads the second images to the server. Optionally, the access privileges provide access to the images for the smart device and the second smart device.

In one embodiment, a method of creating ad hoc image sharing groups includes detecting the creation of a plurality of images by a plurality of users with a CISS system. The method further includes, correlating meta data associated with the plurality of images to determine similarities in the meta data of a subset of the plurality of images. The method further includes assigning a code to the subset of the plurality of images having similarities. Optionally, the similarities are similar location and time of creation for the subset of the plurality of images. Alternatively, the code is a QR code. In one configuration, the code is an event title. In another configuration, a user may create criteria for the correlating. Optionally, the criteria are selected from a group consisting of time an image was created, location an image was created, a creation user that an image was created by, and QR code associated with the image. Alternatively, the creation user is one of a plurality of creation users associated with a particular social group. In one alternative, the correlating is based on analysis of contents of the plurality of images, the contents determined via image analysis that determines what the image is of and coding it accordingly. In another alternative, a user provides a group image, the group image providing a template for matching images from the plurality of images. Optionally, the method further includes detecting that a second subset of the plurality of images have a pre-determined code associated with them; detecting that the subset of the plurality of images has similarities in meta data compared to the second subset; and merging the subset and the second subset of the plurality of images.

### BRIEF DESCRIPTION OF THE DRAWINGS

FIG. 1 shows one embodiment of a Coded Image Sharing System (CISS).

### DETAILED DESCRIPTION

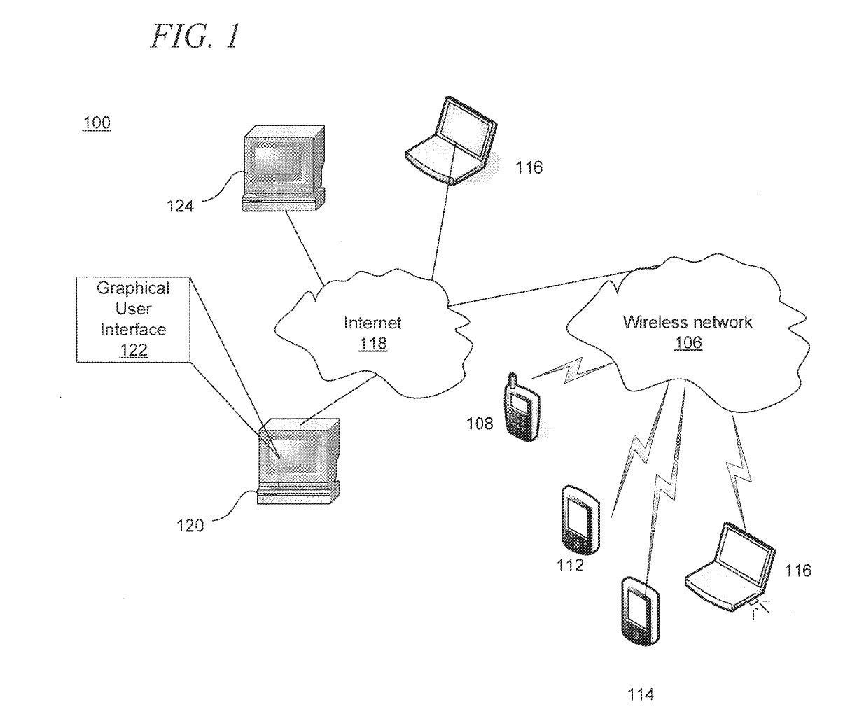

FIG. 1 shows one embodiment of a Coded Image Sharing System (CISS). The CISS 100 includes a combination of software systems running on various distinct pieces of hardware. The CISS system 100 includes a CISS server and various devices implementing CISS applications or software. Photos, images, or videos, although specifically referred to as one or the other, may be interchanged. A variety of systems may be used to collect photos for the CISS server 124. These systems include mobile telephones 108, smart phones 112, tablets and PDAs 114, and computers 116. Mobile telephones 108, smart phones 112, tablets and PDAs 114, and computers 116 may communicate with various wireless networks 106, including Wi-Fi networks, WANs, Bluetooth, NFC, and other types of networks. These devices, termed at times “smart devices,” may include the CISS application for smart devices. Computers 116, 120 or other devices may communicate using a wired LAN to the Internet 118 as well. These devices may implement a graphical user interface 122 on both computers and smart devices. Images captured using non-smart devices may be transferred to computers 116, 120 and processed by CISS software/applications for computers. These wireless networks use the Internet 118 or other packet-switching networks to transfer information. The term “smart devices” may also include digital cameras. These digital cameras may include tagging ability and may include computing modules that allow for customization of tagging protocols or the including of existing tagging protocols. These digital cameras may also include network connectivity, either via an interconnection cable or wireless connection.

Generally, like many social media systems, CISS includes some basic building blocks. Users can create accounts. A user's account may record what permissions the user has to view image collections, create image collections, and create QR code events. The account may have contact preferences, viewing preferences, and other information typically associated with user accounts. Various preferences may control the type of access to images the CISS server is allowed.

The CISS system includes applications for smart devices (may be referred to as a smart application) and applications for general purpose computers that interact with the CISS server. The applications provide the opportunity to the user to collect and upload content, and the CISS server provides for organization and storage of images, creation of QR codes, and the administration of accounts and QR codes.

According to one embodiment, any photo or video may have a number of items of information associated with it. In some alternatives, as mentioned above, a photo (used interchangeably with video) may include a QR code associated with it. In some alternatives, the photo may have a time associated with it. In some alternatives, a photo may have a GPS or other location information associated with it, such as an address. In some alternatives, a photo may have metadata created by the user, such as an identifier of what the picture is, the person shown, the place shown, or other information. In some alternatives, a group and associated tag (metadata) formed according to factors including, but not limited to, an actual event, locations, GPS positioning, social criteria, dates (birthdays, anniversary, etc.) and holidays, clubs, memberships, invitations, landmarks, or proximity to other users of the system. (Such metadata may be subdivided into multiple sub-categories (and, of course, all of the information included may be considered metadata, which is simply data about other data). The photo may have data concerning the network the device was on when the photo was taken, or the type of device on which the photo was taken. Alternatively, data concerning the contents of a photo may be generated based on analyzing the image of the photo. Image reading algorithms may determine what the likely contents of a photo are and label the photo accordingly.

Therefore, embodiments of a CISS may include data categories as follows: time, date, GPS location, address location, user description, QR or event code, network, and algorithm determined image. In some alternatives, these categories may be further broken down into multiple fields. Embodiments of the CISS may include less or more data categories as well.

Various formats for storing this information currently exist, such as XMP (Extensible Metadata Platform) and IPTC (International Press Telecommunications Council). XMP is gradually gaining popularity, and schemas have been released for XMP incorporating IPTC have been produced for using IPTC in a XMP format. Currently, these formats are primarily targeted towards digital rights management. One method of realizing the included system may be realized by utilizing the information contained in such formats. Please note, although special attention has been paid to the XMP format due to its current acceptance and popularity, the CISS system is not exclusive to this format and will function with other formats.

XMP is an XML-based format for pictures; therefore, it provides for virtually unlimited customization to achieve the goals described herein. Standardized data categories may be established for at least the above indicated information. It is believed that over time, as the advantages provided by the CISS become more popular, a substandard of XMP may be produced.

If XMP packets are incorporated into the photo and video format for CISS, the resulting packets need not be exclusive of existing data formats and, in fact, may build on those formats. In some embodiments, a side car of data may be utilized, but this is generally less preferred.

The CISS system includes a software module that may be deployed at a user device. In the case of a smart phone or other mobile device including a camera (IPad or other tablet, IPod or other MP3 player), this software module may be referred to as an “app.” The app may be given various permissions. One permission that may be important to the function of the CISS is the control of the camera and video capture hardware. This allows the CISS app to include XMP packets in images created by the imaging system of the app. As discussed above, the categories created may include data categories not typically included in image metadata, such as a QR code.

Therefore, in use, the user of a CISS system on a smart device produces images or videos with the extended XMP categories discussed above (and some additional ones discussed below). Tagging schemes are discussed below.

Additionally, an app installed on a smart device will periodically scan and upload images according to user preference and the typical function of the device. In some alternatives, this may occur immediately following the creation of an image, according to a set schedule, according to system usage levels, or network bandwidth or preference availability (for instance, the user may indicate that significant bandwidth usage should only occur when Wi-Fi networks are available).

Additionally, the user may take images that have not been tagged by the CISS system and format them according to CISS XMP protocol. This may occur via software in the form of an app on a smart device or a separate application on a computer. When creating an XMP packet on an image, the image may already have some XMP or other meta tags. In such a case (in some configurations), these meta tags are not disregarded. Instead, the meta tags are automatically matched and populated according to syntax-matching mechanisms for the XMP data field names to the meta data existing in the image.

Additionally, users may manually upload images to a CISS website. In such a case, XMP or other meta tags may be created upon upload. This process may occur in an automated fashion when a user uploads a photo. In such a case, the user may select categories about which they wish to enter additional information. This may be menu driven or menu driven with text entry, a combination of both, or another type of entry. Alternatively, the CISS website may simply provide a web-based instance of the same or similar software that executes on a computer as software.

Images or videos uploaded to the CISS website and server (or server system) may be categorized according to various systems and preferences. Images are categorized by QR code, GPS location, GPS location and time, subject matter, image determined according to image analysis, etc.; in essence, any of the categories of meta data (XMP) described above. In one embodiment of the system, all images are categorized simply according to these codes. This, of course, leads to multiple concerns over the privacy considerations of images and user preferences.

Continuing with the above, users may set up events and associate pictures with the event. The administrators of the CISS may perform a similar event setup. If the event is set up beforehand, a code may be associated with the event. Such a code is expressed in many different ways and distributed to users. In some configurations, the CISS system may provide for the creation of QR codes for the user who created the event to distribute at the event. The smart device CISS app includes a self configuration feature, that when a QR code is scanned (or photographed), the QR code is automatically set for subsequent pictures or videos taken. This QR code setting may last for a variable period of time or other constraints, depending on the configuration indicated by the user who created the QR code. Alternatively, the user of a device including a CISS app may override these settings based on affirmative inputs or preferences. Time or constraints of the automatic application of a QR code may be based on the location of the device taking pictures. For instance, the creator of a QR code for CISS may indicate a GPS location or address and a radius around which the QR code should be applied to images. Alternatively, and in many cases, the QR code may only last for a set length of time. Alternatively, the QR code may have time and location expiration limits. Alternatively, the QR code may last for a set number of pictures. Alternatively, the QR code may be set so that the image creator will be affirmatively notified that each image will be included after the image is created, and then the user may opt out (alternatively, it may be an opt in). Alternatively, after the images are captured and uploaded, the user may be notified via email, CISS app, or other system to review and confirm the inclusion at a later date. Combinations of all of these inclusion methodologies are possible as well. In any case, all images uploaded to the CISS with the same QR code are categorized into what will be referred to as an image collection herein. Image collections will be described in greater detail below, including the manipulation of an image collection according to the preferences of the QR code creator or those given access to these preferences.

Alternatively, image collections may be created post hoc according to other characterizations such as events. An event image collection not created by QR code may be created by a user according to the date, time, and location of an event. The CISS website/server in response will retrieve all images that fall within the indicated time and location range. Such an image collection then may be combined with a QR code-based image collection or another collection. Alternatively, an image collection may be based on user description, machine detected photo contents, or any other of the meta tags described above. The CISS system will likely work more smoothly if the images uploaded and grouped include XMP packets of format-standardized information based on the CISS system; however, non-standard images may also be used. In this case, the CISS system may analyze and match available meta data to standard CISS data categories and either sort images based on that or create a new CISS XMP packet for the image.

Access to image collections may be carefully set by the creator of the image collection. QR coded images and the associated preferences may be preset by the creator of the QR code. In many cases, these image collections may be private and only viewable by users indicated by the creator of the QR code and the resulting image collection. Alternatively, anyone producing the QR code may be able to access the image collection. Alternatively, upon scanning the QR code, it becomes associated with an account of a user utilizing the smart device and the CISS app. The actual QR code may remain hidden from the users and, therefore only, be scannable by users at the event. Later, in some configurations, only users with the scanned QR code may access the QR code image collection. In some configurations, access may be granted at a later date in a variety of ways including, but not limited to, invitation or proof of phone number or inclusion in the intended group.

Users may make their own image collection according to any of the meta data described above and then provide access according to their preferences, including, but not limited to, contact lists, other lists, email lists, or other groups selected. Alternatively, access in some may be granted only to those submitting an image meeting the criteria of the image collection.

In some embodiments, users having access to a particular image collection may automatically be notified via email. Alternatively, the images may be added to a personal start or home page that a user accesses via the CISS website. Alternatively, the images may be automatically downloaded to one or more devices.

In one alternative, the user may set preferences that automatically override any QR code indications or other indications that might automatically result in the upload and sharing of pictures. For instance, if the user selects complete privacy, the CISS app on the smart device will only scan and upload images that the user specifically indicates. Alternatively, the CISS may first identify meta data categories of the images and request that the user authorize upload to the categories matching the meta data. Alternatively, the user may set a preference that only QR-associated images be uploaded. Alternatively, the user may actuate free sharing and uploading for a period of time, either by toggling on and off free sharing or by setting a time period or location for which free sharing may be activated. Alternatively, any and all combinations of the above are possible.

In some alternatives, ad hoc groups may be created on the fly. The CISS system may recognize a number of images created within a group of users having some similar characteristics. For instance, if a number of images are created by disparate users in a single geographical location at a particular time, the CISS system may recognize this as an event. The CISS system may then automatically assign QR or other codes to those images. In some alternatives, users within the constrains of the ad hoc group may be notified to ask if they want to be included in the ad hoc group. If they agree, then their images will be assigned to the appropriate QR code and they will be given access to the QR code images. The CISS system may constantly monitor user images for the creation of the ad hoc groups, based on similarities in any of the above-indicated meta data including, but not limited to, GPS location, time, network location, social groups, etc. Combinations of these factors may be used as well. This analysis may be done by the CISS system post hoc as well.

Furthermore, the CISS system may associate ad hoc groups having QR codes with established QR code groups that were created by users or administrators. These groups may then be merged. For example, if a number of images are captured in a certain location at a certain time with a pre-established QR code associated with them and a second group of images are captured at the same time and location but not associated with the QR code, the second group of images may first form an ad hoc QR-coded event. The CISS system then may indicate to the administrator or user who established the pre-established group that he may merge the ad hoc QR-coded event if he wishes.

As an example of a CISS system, in preparation for a wedding, a user may create a QR code to be associated with an event, in this case a wedding. The CISS system will automatically generate the QR code and a record of the code in the CISS system. The user then may distribute the QR code in advance of the event to know users via notification via the CISS, which may occur through the app itself on a smart device or via email containing a link or other dynamic code that will activate the QR code on a user's device. In one alternative, the CISS also may send out invites to others who don't yet have an account via email or other network (Facebook, etc.).

The user (let's call him the groom in this case) then may print out the QR code and send it with invitations or post it at the wedding. Additionally, a separate QR code may be provided that will direct the user's smart device to download the CISS app.

The groom will set the time period and location for which the QR code will last. This will be the time and coordinates (GPS, address, and a radius) of the wedding. When the wedding occurs, those with the QR code will capture images and those images will automatically be uploaded, posted, and shared, assuming the users' preferences allow it. Following the event, the groom may collect additional images not coded originally and associated the QR code with the event. Optionally, the groom may opt to search the CISS for additional photos with matching GPS and time meta data for the wedding and associate these with the event. Other users may associate their pictures with the event post hoc by utilizing the QR code and CISS applications. If the groom had failed to indicate the location and time of the wedding, an ad hoc QR-coded group may be created. The groom may then be notified of this ad hoc group and may merge them with those who pre-indicated the QR code.

At any point during the creation of the image collection, the groom may allow access. This may be allowed from the beginning of the event or as soon as any images are available. This may be after the event at some set time or after review by the groom. In one alternative, those who scanned the QR code and associated it with their account may access the image collection. Alternatively, the groom may invite others to view it via email, etc.

Various embodiments of systems and methods for CISS may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form, such as, but not limited, to source code, compiled code, interpreted code, executable code, static code, dynamic code, and the like. Such a computer-readable medium may include any tangible non-transitory medium for storing information in a form readable by one or more computers, such as, but not limited to, read only memory (ROM); random access memory (RAM); magnetic disk storage media; optical storage media; a flash memory, etc.

Embodiments of systems and methods for CISS described herein may be implemented in a variety of systems, including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

The previous detailed description is of a small number of embodiments for implementing the CISS system and is not intended to be limiting in scope. The following claims set forth a number of the embodiments of the CISS system disclosed with greater particularity.

1. A system for collecting, creating, and distributing images and videos, comprising:
a smart application, executable on a smart device, the smart application providing for the control of the imaging and video capture device of the smart device; and
a server, the server in communication with the smart application via the smart device, the smart application receiving a code, the code being associated with images generated by the smart device resulting in coded images through the control of the smart device by the smart application, the smart application uploading the coded images to the server, the server providing access to the coded images according to access preferences.

2. The system of claim 1 wherein the code is a QR code.

3. The system of claim 2 wherein scanning the QR code with the smart device causes the smart application to associate subsequently captured images with the QR code.

4. The system of claim 3, wherein the subsequently captured images are associated with the QR code only for a set period of time, the set period of time related to the length of an event the QR code is associated.

5. The system of claim 3, wherein the subsequently captured images are associated with the QR code only while a location of the smart device is in a certain geographical area.

6. The system of claim 5 wherein the certain geographical area is associated with an event and the location of the smart device is determined according to GPS.

7. The system of claim 5 wherein the certain geographical area is associated with an event and the location of the smart device is determined according to wireless signals.

8. The system of claim 1 wherein the access preferences define that those users who have scanned the QR code may access the coded images.

9. The system of claim 1 wherein the smart application is executable on a second smart device, and when the second smart device captures second images after receiving the code, the second smart device associates the code with the second images and uploads the second images to the server.

10. The system of claim 9 wherein the access privileges provide access to the images for the smart device and the second smart device.

11. A method of creating ad hoc image sharing groups, the method comprising:
detecting the creation of a plurality of images by a plurality of users with a CISS system;
correlating meta data associated with the plurality of images to determine similarities in the meta data of a subset of the plurality of images; and
assigning a code to the subset of the plurality of images having similarities.

12. The method of claim 11 wherein the similarities are similar location and time of creation for the subset of the plurality of images.

13. The method of claim 11 wherein the code is a QR code.

14. The method of claim 11 wherein the code is an event title.

15. The method of claim 11 wherein a user may create criteria for the correlating.

16. The method of claim 15, wherein the criteria are selected from a group consisting of time an image was created, location an image was created, a creation user that an image was created by, and QR code associated with the image.

17. The method of claim 16, wherein the creation user is one of a plurality of creation users associated with a particular social group.

18. The method of claim 11, wherein the correlating is based on analysis of contents of the plurality of images, the contents determined via image analysis that determines what the image is of and coding it accordingly.

19. The method of claim 18, wherein a user provides a group image, the group image providing a template for matching images from the plurality of images.

20. The method of claim 11, further comprising:
detecting that a second subset of the plurality of images have a pre-determined code associated with them;
detecting that the subset of the plurality of images has similarities in meta data compared to the second subset; and
merging the subset and the second subset of the plurality of images.
